(19) United States
(12) Patent Application Publication
(10) Pub. No.: US 2026/0193571 A1
(43) Pub. Date: Jul. 9, 2026

(54) AQUEOUS COMPOSITION CONTAINING CUCURBITURILS

(71) Applicant: Clariant International Ltd, Muttenz (CH)

(72) Inventors: Xiaoqiang GUO, Frankfurt am Main (DE); Natascha SCHELERO, Hamburg (DE)

(73) Assignee: Clariant International Ltd, Muttenz (CH)

(21) Appl. No.: 19/131,651

(22) PCT Filed: Dec. 8, 2023
(86) PCT No.: PCT/EP2023/084996

§ 371 Date: May 21, 2025

(30) Foreign Application Priority Data
Dec. 12, 2022 (EP) 22212699.7

(51) Int. Cl. C11D 3/37

(52) U.S. Cl. CPC C11D 3/3776

(57) ABSTRACT

Aqueous compositions comprising one or more cucurbiturils, one or more solubilizing agents and water are described. These aqueous compositions may advantageously be used in laundry detergent formulations, fabric conditioners, automatic dishwashing rinse aid formulations, hand dishwashing liquids, air fresheners or hard surface cleaners to remove malodor.

The present invention relates to aqueous compositions comprising one or more cucurbiturils, one or more solubilizing agents and water, to laundry detergent formulations, fabric conditioners, automatic dishwashing rinse aid formulations, hand dishwashing liquids, air fresheners or hard surface cleaners comprising the aqueous compositions, to the use of the aqueous compositions for the preparation of laundry detergent formulations, fabric conditioners, automatic dishwashing rinse aid formulations, hand dishwashing liquids, air fresheners or hard surface cleaners and to the use of the aqueous compositions in laundry detergent formulations, fabric conditioners, automatic dishwashing rinse aid formulations, hand dishwashing liquids, air fresheners or hard surface cleaners to remove malodor.

Cucurbiturils, due to their barrel-like structures, are known to bind a number of substances to form host-guest compounds and, for this reason, have high application potential in a number of applications in home care.

Cucurbiturils made from an industrial process usually contain more than one substance, e.g. a mixture of cucurbit[5]uril, cucurbit[6]uril, cucurbit[7]uril, cucurbit[8]uril. However, many of these cucurbiturils have very poor water solubilities, e.g. cucurbit[6]uril 18 mg/L in water and cucurbit[8]uril 17 mg/L in water at room temperature (25° C.). Due to their poor solubilities, it is difficult to formulate industrial grade cucurbiturils into aqueous formulations to get homogenous compositions, e.g. in the area of consumer care.

U.S. Pat. No. 10,881,592 B2 discloses a stable suspension composition comprising cucurbituril particles suspended in a medium, wherein the cucurbituril particles have an average particle size of from about 0.25 μm to about 50 μm. It can be used in a few consumer care products in the form of suspensions. However, in many other consumer care products, e.g. laundry detergents, solutions are highly preferred.

U.S. Pat. No. 6,869,466 B1 discloses an aqueous solution comprising a solubilizing agent for increasing the solubility of the cucurbituril in the aqueous solution, where the solubilizing agent is selected from the group consisting of metal salts, ammonium salts, acids and polyhydroxylated organic compounds. However, most of those solubilizing agents are not compatible with consumer care products and the solubility increase gained from using those solubilizing agents is also not sufficient.

There is still a need for substances that solubilize cucurbiturils efficiently in water, so that cucurbiturils can be used in consumer products for malodor removal.

The object of the present invention is to provide aqueous compositions which comprise solubilized cucurbiturils and can be used in consumer care products to remove malodor.

It has been found that this object is achieved by aqueous compositions comprising
Z1) one or more cucurbiturils selected from the group consisting of cucurbit[5]uril, cucurbit[6]uril, cucurbit[7]uril, cucurbit[8]uril and mixtures thereof,

and
Z2) one or more solubilizing agents selected from
   a) one or more discrete molecules containing nitrogen, or
   b) one or more polymers comprising one or more structural units derived from one or more monomers containing nitrogen, or
   mixtures thereof,

and
Z3) water.

A subject matter of the present invention therefore is aqueous compositions comprising
Z1) one or more cucurbiturils selected from the group consisting of cucurbit[5]uril, cucurbit[6]uril, cucurbit[7]uril, cucurbit[8]uril and mixtures thereof,

and
Z2) one or more solubilizing agents selected from
   a) one or more discrete molecules containing nitrogen, or
   b) one or more polymers comprising one or more structural units
   derived from one or more monomers containing nitrogen, or mixtures thereof,

and
Z3) water.

Cucurbiturils are barrel-like molecules which can be prepared according to the process described in U.S. Pat. No. 10,626,119 B2.

A solubilizing agent of component Z2) of the aqueous compositions according to the invention refers to a group of chemical substances that can increase the solubility of cucurbiturils in water.

The one or more structural units of the one or more polymers b) of component Z2) of the aqueous compositions according to the invention encompass repeating structural units and terminal groups.

A discrete molecule a) of component Z2) of the aqueous compositions according to the invention refers to a non-polymeric molecule with a defined chemical structure and a defined molar mass.

The inventive aqueous compositions have the advantage that they may contain a high amount of cucurbiturils in water and are present as clear or only slightly turbid solutions and can be used in consumer care products, such as laundry detergent formulations, fabric conditioners, automatic dishwashing rinse aid formulations, hand dishwashing liquids, air fresheners or hard surface cleaners, to remove malodor.

The term “malodor” in the context of the invention refers to an unpleasant smell, which is often perceived on fabrics, such as clothes, bedlinen and bathing towels etc., on kitchenware, such as plates, plastic food containers etc., in the air in kitchens or bathrooms, or on surfaces of toilets and countertops in kitchens.

Preferably, component Z1) of the inventive aqueous compositions comprises
a) cucurbit[5]uril in an amount from 0 to 20% by weight, more preferably in an amount from 0 to 10% by weight and even more preferably in an amount from 0 to 5% by weight; and
b) cucurbit[6]uril in an amount from 30 to 70% by weight, more preferably in an amount from 35 to 65% by weight and even more preferably in an amount from 40 to 60% by weight; and
c) cucurbit[7]uril in an amount from 20 to 50% by weight, more preferably in an amount from 25 to 45% by weight and even more preferably in an amount from 30 to 40% by weight; and
d) cucurbit[8]uril in an amount from 0 to 30% by weight, more preferably in an amount from 0 to 20% by weight and even more preferably in an amount from 5 to 15% by weight;
in each case based on the total weight of component Z1).

In a more preferred embodiment of the invention, component Z1) of the inventive aqueous compositions comprises
a) cucurbit[5]uril in an amount from 0 or 0.1 to 20% by weight, even more preferably in an amount from 0 or 0.1 to 10% by weight and particularly preferably in an amount from 0 or 0.1 to 5% by weight; and
b) cucurbit[6]uril in an amount from 30 to 69.9% by weight, even more preferably in an amount from 35 to 64.9% by weight and particularly preferably in an amount from 40 to 59.9% by weight; and
c) cucurbit[7]uril in an amount from 20 to 50% by weight, even more preferably in an amount from 25 to 45% by weight and particularly preferably in an amount from 30 to 40% by weight; and
d) cucurbit[8]uril in an amount from 0 to 30% by weight, even more preferably in an amount from 0 to 20% by weight and particularly preferably in an amount from 5 to 15% by weight;
in each case based on the total weight of component Z1).

In a preferred embodiment of the invention, the lower limit of cucurbit[5]uril in component Z1) of the inventive aqueous compositions is 0.1% by weight, based on the total weight of component Z1).

Preferably, the one or more discrete molecules a) of component Z2) of the aqueous compositions according to the invention are selected from the group consisting of amine oxides, betaines, quats, glucamides, glucamines, and mixtures thereof.

Preferably, the amine oxides are alkyl and/or alkenyl amine oxides, more preferably alkyl amine oxides and even more preferably C8-C18 alkylamine oxides, and alkyl and/or alkenyl dimethyl amine oxides, more preferably alkyl dimethyl amine oxides and even more preferably C8-C18 alkyl dimethyl amine oxides.

In a particularly preferred embodiment of the invention, the amine oxides are selected from the group consisting of cocamine oxide, myristyl dimethylamine oxide, lauryl dimethylamine oxide, octyl dimethylamine oxide and mixtures thereof.

Among the alkyl and/or alkenyl amine oxides, the alkyl amine oxides are preferred.

Among the alkyl and/or alkenyl dimethyl amine oxides, the alkyl dimethyl amine oxides are preferred.

Preferably, the betaines are alkyl and/or alkenyl dimethyl betaines, more preferably C8-C18 alkyl and/or alkenyl dimethyl betaines and even more preferably C8-C16 alkyl dimethyl betaines, and alkyl and/or alkenyl amido propyl betaines, more preferably C8-C18 alkyl and/or alkenyl amido propyl betaines and even more preferably C8-C16 alkyl amido propyl betaines.

In a particularly preferred embodiment of the invention, the betaines are selected from the group consisting of cocoyl dimethyl betaine, myristyl dimethyl betaine, lauryl dimethyl betaine, octyl dimethyl betaine, cocamidopropyl betaine, and mixtures thereof.

Among the alkyl and/or alkenyl dimethyl betaines, the alkyl dimethyl betaines are preferred. Among the alkyl and/or alkenyl amido propyl betaines, the alkyl amido propyl betaines are preferred.

Preferably, the quats are selected from the formula (IX)

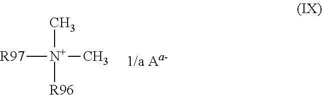

wherein
R96 is a linear alkyl group having 1 to 6 carbon atoms, preferably 1 to 4 carbon atoms, and more preferably is a methyl group; or a linear hydroxylalkyl group having 1 to 6 carbon atoms, preferably 1 to 4 carbon atoms, and more preferably is a hydroxylethyl group,
R97 is a linear or branched, preferably a linear, alkyl group having 8 to 22 and preferably 8 to 18 carbon atoms, and
1/a A^{a-} is an anion, preferably selected from the group consisting of monovalent anions A⁻ (a=1), divalent anions % A²⁻ (a=2) and trivalent anions ⅓ A³⁻ (a=3) and more preferably selected from the group consisting of Cl⁻ (chloride), Br⁻ (bromide), CH₃—SO₄⁻ (methyl sulfate), C₂H₅—SO₄⁻ (ethyl sulfate), HCOO⁻ (formate), ⅓ C(OH)(COO⁻)(CH₂COO⁻)₂ (citrate), CH₃—COO⁻ (acetate), NO₃⁻ (nitrate), ½ CO₃²⁻ (carbonate), ½ SO₄²⁻ (sulfate) and ⅓ PO₄³⁻ (phosphate).

In a more preferred embodiment of the invention, in formula (IX),
R96 is a hydroxylethyl group,
R97 is a linear alkyl group having 8 to 10 carbon atoms, and
1/a A^{a-} is an anion, preferably selected from the group consisting of monovalent anions A⁻ (a=1), divalent anions ½ A²⁻ (a=2) and trivalent anions ⅓ A³⁻ (a=3) and more preferably selected from the group consisting of Cl⁻ (chloride), Br⁻ (bromide), CH₃—SO₄⁻ (methyl sulfate), C₂H₅—SO₄⁻ (ethyl sulfate), HCOO⁻ (formate), ⅓ C(OH)(COO⁻)(CH₂COO⁻)₂ (citrate), CH₃—OOO⁻ (acetate), NO₃⁻ (nitrate), ½ CO₃²⁻ (carbonate), ½ SO₄²⁻ (sulfate) and ⅓ PO₄³⁻ (phosphate).

In a further, more preferred embodiment of the invention, in formula (IX),
R96 is a hydroxylethyl group,
R97 is a linear alkyl group having 12 to 14 carbon atoms, and
1/a A^{a-} is an anion, preferably selected from the group consisting of monovalent anions A⁻ (a=1), divalent anions ½ A²⁻ (a=2) and trivalent anions ⅓ A³⁻ (a=3) and more preferably selected from the group consisting of Cl⁻ (chloride), Br⁻ (bromide), CH₃—SO₄⁻ (methyl sulfate), C₂H₅—SO₄⁻ (ethyl sulfate), HCOO⁻ (formate), ⅓ C(OH)(COO⁻)(CH₂COO⁻)₂ (citrate), CH₃—OOO (acetate), NO₃⁻ (nitrate), ½ CO₃²⁻ (carbonate), ½ SO₄²⁻ (sulfate) and ⅓ PO₄³⁻ (phosphate).

Preferably, the glucamides are N-hydrocarbon substituted-N-acyl-glucamides selected from the formula (X)

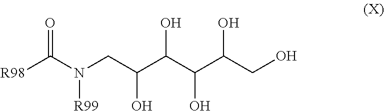

wherein
R98 is a linear or branched, preferably a linear, alkyl group having 7 to 21 and preferably 7 to 17 carbon atoms, or a linear or branched, preferably a linear, alkenyl group having one or more double bonds and 7 to 21, preferably 7 to 17, carbon atoms, and
R99 is a linear or branched, preferably a linear, alkyl group having 1 to 6 carbon atoms, more preferably a methyl, ethyl, propyl or butyl group, and even more preferably a methyl group.

More preferably,
R98CO in formula (X) is selected from the group consisting of capryloyl, pelargonoyl, caprinoyl, undecyloyl, lauroyl, tridecyloyl, myristoyl, pentadecyloyl, palmitoyl, margaroyl, stearoyl, myristoleoyl, pamitoleoyl, oleoyl, linolenoyl, and mixtures thereof.

In an even more preferred embodiment of the invention, in formula (X),
R98 is a linear alkyl group having 11 to 13 carbon atoms and
R99 is a methyl group, or
R98CO derives from coconut oil and
R99 is a methyl group, or
R98CO derives from sunflower oil and
R99 is a methyl group.

In a particularly preferred embodiment of the invention, in formula (X),
R98 is a linear alkyl group having 11 to 13 carbon atoms and
R99 is a methyl group.

In a further particularly preferred embodiment of the invention, in formula (X),
R98CO derives from coconut oil and
R99 is a methyl group.

In a further particularly preferred embodiment of the invention, in formula (X),
R98CO derives from sunflower oil and
R99 is a methyl group.

Preferably, the glucamines are selected from the compounds of the formula (IV)

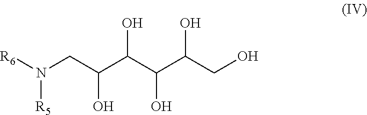

wherein
R5 and R6 are, independently of one another, hydrogen, a linear or branched alkyl group having 1 to 20 carbon atoms or a linear or branched alkenyl group having 2 to 20 carbon atoms, preferably hydrogen, a linear or branched alkyl group having 1 to 16 carbon atoms or a linear or branched alkenyl group having 2 to 16 carbon atoms, more preferably hydrogen, a linear or branched alkyl group having 1 to 10 carbon atoms or a linear or branched alkenyl group having 2 to 10 carbon atoms, even more preferably hydrogen, a linear or branched alkyl group having 1 to 4 carbon atoms or a linear or branched alkenyl group having 2 to 4 carbon atoms, and particularly preferably, are methyl groups.

Preferably, the one or more polymers b) of component Z2) of the aqueous compositions according to the invention comprise one or more structural units derived from one or more monomers of the formulae (I), (II-a), (II-b), (II-c), (III), N-methyl-N-alkylamines, aziridine, vinylpyrrolidone, vinylimidazole, or mixtures thereof

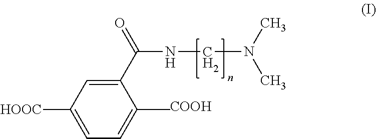

wherein
n is an integer from 1 to 20, preferably from 1 to 10, more preferably from 1 to 6, even more preferably is 2 or 3 and particularly preferably is 3,

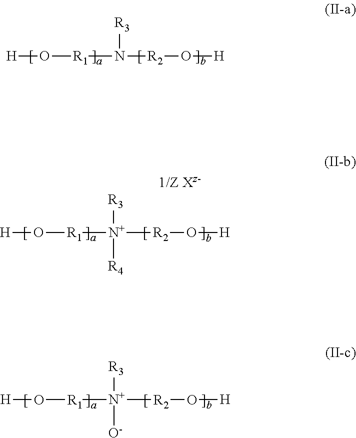

wherein
R₁ and R₂ are, independently of one another, selected from linear or branched alkylene groups represented by the formula (CₙH₂ₙ) wherein n is 2, 3 or 4,
R₃ is a group of the formula —(CⱼH₂ⱼO)ₖ—R₉₈, wherein j is 2, 3 or 4, preferably 2, k is, based on a molar average, a number from 0 to 10, preferably from 0 to 5, more preferably from 0 to 2 and even more preferably is 0, and R₉₈ is selected from the group consisting of alkyl, alkenyl, hydroxyalkyl, hydroxyalkenyl, phenyl alkyl, phenyl alkenyl, alkyl phenyl, and alkenyl phenyl, wherein the alkyl and alkenyl groups, either as such or as a part of the aforementioned hydroxyalkyl, hydroxyalkenyl, phenyl alkyl, phenyl alkenyl, alkyl phenyl or alkenyl phenyl groups, contain 6 or more than 6 carbon atoms, preferably from 6 to 30 carbon atoms and more preferably from 6 to 22 carbon atoms,
R₄ is a group of the formula —(Cⱼ₁H₂ⱼ₁O)ₖ₁—R₉₉, wherein j1 is 2, 3 or 4, preferably 2, k1 is, based on a molar average, a number from 0 to 10, preferably from 0 to 5, more preferably from 0 to 2 and even more preferably is 0, and R₉₉ is selected from the group consisting of hydrogen, alkyl, alkenyl, hydroxyalkyl, hydroxyalkenyl, phenyl alkyl, phenyl alkenyl, alkyl phenyl, and alkenyl phenyl, wherein the alkyl groups, either as such or as a part of the aforementioned hydroxyalkyl, phenyl alkyl or alkyl phenyl groups, contain from 1 to 30 carbon atoms, preferably from 1 to 22 carbon atoms and more preferably from 1 to 6 carbon atoms, and wherein the alkenyl groups, either as such or as a part of the aforementioned hydroxyalkenyl, phenyl alkenyl or alkenyl phenyl groups, contain from 2 to 30 carbon atoms, preferably from 2 to 22 carbon atoms and more preferably from 2 to 6 carbon atoms,
a and b are, based on a molar average, independently of one another, numbers from 1 to 200, preferably from 1 to 100, more preferably from 1 to 50, even more preferably from 1 to 25, and particularly preferably from 1 to 10, and
1/z X^{z-} is an anion, preferably selected from the group consisting of monovalent anions X⁻ (z=1), divalent anions ½ X²⁻ (z=2) and trivalent anions ⅓ X³⁻ (z=3) and more preferably selected from the group consisting of Cl⁻ (chloride), Br⁻ (bromide), CH₃—SO₄⁻ (methyl sulfate), C₂H₅—SO₄⁻ (ethyl sulfate), HCOO⁻ (formate),
⅓ C(OH)(COO⁻)(CH₂COO⁻)₂ (citrate), CH₃—COO⁻ (acetate), NO₃⁻ (nitrate), ½ CO₃² (carbonate), ½ SO₄²⁻ (sulfate) and ⅓ PO₄³⁻ (phosphate),

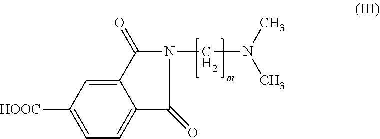

wherein
m is an integer from 1 to 20, preferably from 1 to 10, more preferably from 1 to 6, even more preferably is 2 or 3, and particularly preferably is 3.

In a more preferred embodiment of the invention, the one or more polymers b) of component Z2) of the aqueous compositions according to the invention comprise one or more structural units derived from one or more monomers of the formulae (I), (II-a), (II-b), (II-c), (III), or mixtures thereof. These polymers b) are polyesters.

In an even more preferred embodiment of the invention, the one or more polymers b) of component Z2) of the aqueous compositions according to the invention that comprise one or more structural units derived from one or more monomers of the formulae (I), (II-a), (II-b), (II-c), (III), or mixtures thereof, further comprise
A) one or more structural units derived from terephthalic acid or dimethyl terephthalate, and
B) one or more structural units derived from ethylene glycol or propylene glycol.

In a particularly preferred embodiment of the invention, the one or more polymers b) of component Z2) of the aqueous compositions according to the invention that comprise one or more structural units derived from one or more monomers of the formulae (I), (II-a), (II-b), (II-c), (III), or mixtures thereof, and further comprise one or more structural units A) and one or more structural units B), further comprise one or more structural units derived from one or more polyalkyleneglycol monoalkylethers of the formula (V)

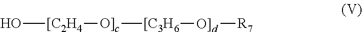

wherein,
R₇ is linear or branched (C₁-C₃₀)-alkyl, preferably linear or branched (C₁-C₄)-alkyl, and more preferably methyl,
c and d are, based on a molar average, independently of one another, numbers from 0 to 200, and the sum of c+d is from 2 to 400, preferably from 2 to 350 and more preferably from 2 to 150, the [C₂H₄—O] and [C₃H₆—O]groups of the formula (V) may be arranged blockwise, alternating, periodically and/or statistically, preferably blockwise and/or statistically, and either of the [C₂H₄—O] and [C₃H₆—O]groups of the formula (V) can be linked to —R₇ and/or —OH.

In an extraordinarily preferred embodiment of the invention, the one or more polymers b) of component Z2) of the aqueous compositions according to the invention are selected from the group consisting of polymers comprising one or more structural units derived from one or more monomers of the formulae (I) or (III) or mixtures thereof, and one or more structural units derived from one or more monomers of the formula (V), and one or more structural units of the component A) and one or more structural units of the component B);
polymers comprising one or more structural units derived from one or more monomers of the formula (II-a), and one or more structural units derived from one or more monomers of the formula (V), and one or more structural units of the component A) and one or more structural units of the component B); polymers comprising one or more structural units derived from one or more monomers of the formula (II-b), and one or more structural units derived from one or more monomers of the formula (V), and one or more structural units of the component A) and one or more structural units of the component B); and polymers comprising one or more structural units derived from one or more monomers of the formula (II-c), and one or more structural units derived from one or more monomers of the formula (V), and one or more structural units of the component A) and one or more structural units of the component B).

In a further, more preferred embodiment of the invention, the one or more polymers b) of component Z2) of the aqueous compositions according to the invention comprise one or more structural units derived from one or more N-methyl-N-alkylamines, aziridine, or mixtures thereof.

In an even more preferred embodiment of the invention, the one or more polymers b) of component Z2) of the aqueous compositions according to the invention that comprise one or more structural units derived from one or more N-methyl-N-alkylamines further comprise one or more structural units derived from epichlorohydrin. Particularly preferably, the alkyl group in the N-methyl-N-alkylamine is methyl(N,N-dimethylamines). An extraordinarily preferred example is Texcare DFC 6 pre, a dimethylamine-epichlorohydrin copolymer.

In another even more preferred embodiment of the invention, the one or more polymers b) of component Z2) of the aqueous compositions according to the invention that comprise one or more structural units derived from aziridine further comprise one or more structural units derived from ethylene oxide. A particularly preferred example is Sokalan HP 56, an ethoxylated polyethyleneimine.

In a further, more preferred embodiment of the invention, the one or more polymers b) of component Z2) of the aqueous compositions according to the invention comprise one or more structural units derived from vinylpyrrolidone, vinylimidazole, or mixtures thereof.

In an even more preferred embodiment of the invention, the one or more polymers b) of component Z2) of the aqueous compositions according to the invention comprise one or more structural units derived from vinylpyrrolidone and one or more structural units derived from vinylimidazole. A particularly preferred example is Sokalan HP 56 K, a vinylpyrrolidone/vinylimidazole copolymer.

Preferably, the aqueous compositions according to the invention comprise the one or more cucurbiturils of component Z1) in an amount from 0.01 to 10% by weight, more preferably in an amount from 0.01 to 5% by weight and even more preferably in an amount from 0.01 to 2% by weight, in each case based on the total weight of the aqueous compositions.

Preferably, the aqueous compositions according to the invention comprise the one or more solubilizing agents of component Z2) in an amount from 0.01 to 50% by weight, more preferably in an amount from 0.01 to 25% by weight and even more preferably in an amount from 0.01 to 10% by weight, in each case based on the total weight of the aqueous compositions.

Preferably, the weight ratio of the one or more cucurbiturils of component Z1) and the one or more solubilizing agents of component Z2) (Z1): Z2)) in the aqueous compositions according to the invention is from 1:1 to 1:50, more preferably from 1:1 to 1:20 and even more preferably from 1:1 to 1:10.

The aqueous compositions according to the invention may advantageously be used for the preparation of laundry detergent formulations, fabric conditioners, automatic dishwashing rinse aid formulations, hand dishwashing liquids, air fresheners or hard surface cleaners.

A further subject matter of the present invention is laundry detergent formulations, fabric conditioners, automatic dishwashing rinse aid formulations, hand dishwashing liquids, air fresheners or hard surface cleaners comprising an aqueous composition according to the invention.

A further subject matter of the present invention is the use of an aqueous composition according to the invention for the preparation of a laundry detergent formulation, fabric conditioner, automatic dishwashing rinse aid formulation, hand dishwashing liquid, air freshener or hard surface cleaner.

The aqueous compositions according to the invention may advantageously be used in laundry detergent formulations, fabric conditioners, automatic dishwashing rinse aid formulations, hand dishwashing liquids, air fresheners or hard surface cleaners to remove malodor.

A further subject matter of the present invention is the use of an aqueous composition according to the invention in laundry detergent formulations, fabric conditioners, automatic dishwashing rinse aid formulations, hand dishwashing liquids, air fresheners or hard surface cleaners to remove malodor.

Laundry detergent formulations may contain further ingredients typically used therein and known to the person skilled in the art, such as anionic surfactants, nonionic surfactants and water.

Fabric conditioners may contain further ingredients typically used therein and known to the person skilled in the art, such as esterquats and water.

Automatic dishwashing rinse aid formulations may contain further ingredients typically used therein and known to the person skilled in the art, such as alcohol alkoxylates and water.

Hand dishwashing liquids may contain further ingredients typically used therein and known to the person skilled in the art, such as anionic surfactants, zwitterionic surfactants and water.

Air fresheners may contain further ingredients typically used therein and known to the person skilled in the art, such as nonionic surfactants and water.

Hard surface cleaners may contain further ingredients typically used therein and known to the person skilled in the art, such as nonionic surfactants and water.

The examples below are intended to illustrate the invention in detail without, however, limiting it thereto.

Example 1—Increasing the solubility of cucurbiturils in water A cucurbituril sample, which contains cucurbit[6]uril (50% by weight), cucurbit[7]uril (35% by weight) and cucurbit[8]uril (10% by weight), and solubilizing agents according to component Z2) of the inventive aqueous compositions were added to water and stirred at room temperature (25° C.) for at least 1 hour.

Compositions consisting of the cucurbituril sample and water and compositions consisting of the cucurbituril sample, other substances but no solubilizing agents according to component Z2) of the inventive aqueous compositions, and water were prepared and used as comparative compositions.

The ingredients and appearance of aqueous compositions comprising cucurbiturils are shown in Table 1.

TABLE 1
Ingredients and appearance of aqueous compositions comprising cucurbiturils

| | substances (numbers | Concentration | |
|---|---|---|---|
| | in brackets refer | of cucurbituril | |
| | to their concentration | sample in the | |
| | in the aqueous | aqueous | |
| | composition in percent | composition in | |
| | by weight) | percent by weight | Appearance |
| Compositions | — | 0.2 | very turbid |
| consisting of | — | 0.5 | very turbid |
| the cucurbi- | — | 1 | very turbid |
| turil sample | | | |
| and water | | | |
| no solubilizing | NaCl (10) | 0.2 | very turbid |
| agent according | CaCl₂ (10) | 0.2 | very turbid |
| to component | C12/14 alkyl ethoxylate with | 0.2 | very turbid |
| Z2) of the | 8 EO (5) | | |
| inventive | Sodium laureth sulfate (5) | 0.2 | very turbid |
| aqueous | Alkylbenzene sulfonate (5) | 0.2 | very turbid |
| compositions | Propylene glycol (10) | 0.2 | very turbid |
| | Ethanol (10) | 0.2 | very turbid |
| solubilizing | Sokalan HP 20 (ethoxylated | 0.2 | slightly turbid |
| agent | polyethyleneimine) | | to clear |
| according to | Sokalan HP 56K | 0.2 | clear |
| component | (Vinylpyrrolidone/ | | |
| Z2) of the | Vinylimidazole | | |
| inventive | copolymer) | | |
| aqueous | Polymer comprising structural | 0.2 | slightly turbid |
| compositions | units derived from formula (I) | | to clear |
| (5% by weight | Genagen CAB 818 | 0.5 | clear |
| active matter | (alkylamidopropyl betaine) | | |
| of solubilizing | Genagen CAB 818 | 1 | slightly turbid |
| agent in | (alkylamidopropyl betaine) | | to clear |
| aqueous | Genaminox LA (lauramine | 0.2 | clear |
| compositions) | oxide) | | |
| | Genaminox LA (lauramine | 0.5 | slightly turbid |
| | oxide) | | to clear |
| | TexCare DFC 6 pre | 1 | clear |
| | Genamin Gluco 50 (compound | 0.2 | clear |
| | of the formula (IV) wherein | | |
| | R5 and R6 are methyl) | | |

The results of Table 1 show that the appearance of the aqueous compositions comprising cucurbiturils is very turbid when no solubilizing agent according to component Z2) of the inventive aqueous compositions is present in the aqueous composition. However, when a solubilizing agent according to component Z2) of the inventive aqueous compositions is present in the aqueous composition, the appearance of the aqueous composition becomes slightly turbid to clear or even becomes clear. This indicates that substances according to component Z2) of the inventive aqueous compositions are effective as solubilizing agents.

### EXAMPLE 2—MALODOR REMOVING EFFECT

### Malodor Composition:

An artificial malodor composition was prepared by mixing 10 mg of 2,3-butanedione, 5 mg of octanal, 30 mg of isovaleraldehyde, 300 mg of isovaleric acid and 50 mg of hexanal in 1 L of water.

### Cucurbituril Sample:

The cucurbituril sample contains cucurbit[6]uril (50% by weight), cucurbit[7]uril (35% by weight) and cucurbit[8]uril (10% by weight).

Aqueous cucurbituril compositions A and B:

Aqueous cucurbituril composition A: 5% by weight of solubilizing agent and 0.5% by weight of the cucurbituril sample were mixed in water and stirred to form slightly turbid to clear solutions.

Aqueous cucurbituril composition B: 0.5% by weight of the cucurbituril sample was mixed in water.

### Method of Malodor Measurement:

1 mL of aqueous cucurbituril composition A or B, 1 mL of malodor composition and 3 mL of water were mixed.

1 mL of 5% by weight of solubilizing agent in water, 1 mL of malodor composition and 3 mL of water were mixed.

4 mL of water and 1 mL of malodor composition were mixed.

The mixtures were prepared in headspace vials. The vials were then closed tightly and analyzed.

Analytical evaluation of malodor in the vials was conducted through a headspace measurement. A Gas Chromatograph Agilent 9000 Intuvo equipped with an autosampler Agilent 7697A equipped with a headspace extracting syringe, a Mass Detector Agilent MSD 5977B was used.

The headspace vials were equilibrated at 60° C. for 30 min at the autosampler before the measurement. A gas phase sample of 1000 μL was extracted from the vial and injected into the GC column.
Carrier gas: Helium 22.7 psi, split 5:1
Column: DB-624 UI (length 60m, diameter 250 μm, size of film 1.4 μm)
Oven: Initial 40° C.—Hold time 2 mb—Rate 20° C./min—Temperature 260° C. —Hold time 5 min
Mass detector parameter: run in select ion mode. The peak area of each odorant was then integrated and recorded.

The relative peak areas for the odorants measured in the sample headspace are shown in Table 2.

TABLE 2
Relative peak areas for odorants measured in sample headspace

| | Mixture | 2,3- | | | | |
|---|---|---|---|---|---|---|
| Solubilizing | contains | buta- | isovaler- | hexa- | isovaleric | octa- |
| agent | cucurbiturils? | dione | aldehyde | nal | acid | nal |
| no | no | 100* | 100* | 100* | 100* | 100* |
| | yes | 237 | 256 | 354 | 113 | 135 |
| Sokalan HP | no | 190 | 232 | 279 | 10 | 103 |
| 20 | yes | 25 | 27 | 26 | 0 | 20 |
| Sokalan HP | no | 202 | 196 | 252 | 10 | 105 |
| 56 K | yes | 23 | 20 | 29 | 0 | 50 |
| Genaminox | no | 181 | 182 | 203 | 10 | 134 |
| LA | yes | 11 | 6 | 9 | 3 | 73 |
| Polymer | no | 157 | 143 | 207 | 181 | 118 |
| comprising | yes | 24 | 27 | 27 | 54 | 13 |
| structural | | | | | | |
| units | | | | | | |
| derived | | | | | | |
| from | | | | | | |
| formula (I) | | | | | | |

*The peak areas of the individual odorants in the example containing neither solubilizing agent nor cucurbiturils were normalized as 100.

The results of Table 2 show that the cucurbiturils in water do not remove malodor when no solubilizing agent according to component Z2) of the inventive aqueous compositions is present in the mixture but when a solubilizing agent according to component Z2) of the inventive aqueous compositions is present in the mixture, the cucurbiturils in water remove malodor efficiently.

1-10. (canceled)

11. An aqueous composition comprising
Z1) one or more cucurbiturils selected from the group consisting of cucurbit[5]uril, cucurbit[6]uril, cucurbit[7]uril, cucurbit[8]uril, and mixtures thereof;
Z2) one or more solubilizing agents selected from
a) one or more discrete molecules containing nitrogen,
b) one or more polymers comprising one or more structural units derived
from one or more monomers containing nitrogen, and
mixtures of a) and b);
and
Z3) water.

12. The aqueous composition according to claim 11, wherein the component Z1) comprises
a) cucurbit[5]uril in an amount from 0 to 20% by weight,
b) cucurbit[6]uril in an amount from 30 to 70% by weight,
c) cucurbit[7]uril in an amount from 20 to 50% by weight, and
d) cucurbit[8]uril in an amount from 0 to 30% by weight,
in each case based on the total weight of component Z1).

13. The aqueous composition according to claim 11, wherein the component Z1) comprises
a) cucurbit[5]uril in an amount from 0.1 to 20% by weight,
b) cucurbit[6]uril in an amount from 30 to 69.9% by weight,
c) cucurbit[7]uril in an amount from 20 to 50% by weight, and
d) cucurbit[8]uril in an amount from 0 to 30% by weight,
in each case based on the total weight of component Z1).

14. The aqueous composition according to claim 11, wherein the component Z1) comprises
a) cucurbit[5]uril in an amount from 0 to 5% by weight,
b) cucurbit[6]uril in an amount from 40 to 60% by weight,
c) cucurbit[7]uril in an amount from 30 to 40% by weight, and
d) cucurbit[8]uril in an amount from 5 to 15% by weight,
in each case based on the total weight of component Z1).

15. The aqueous composition according to claim 11, wherein the component Z1) comprises
a) cucurbit[5]uril in an amount from 0.1 to 5% by weight,
b) cucurbit[6]uril in an amount from 40 to 59.9% by weight,
c) cucurbit[7]uril in an amount from 30 to 40% by weight, and
d) cucurbit[8]uril in an amount from 5 to 15% by weight,
in each case based on the total weight of component Z1).

16. The aqueous composition according to claim 11, wherein the one or more discrete molecules a) of component Z2) are selected from the group consisting of amine oxides, betaines, quats, glucamides, glucamines, and mixtures thereof.

17. The aqueous composition according to claim 11, wherein the one or more polymers b) of component Z2) comprise one or more structural units derived from N-methyl-N-alkylamines, aziridine, vinylpyrrolidone, vinylimidazole, or one or more monomers of the formulae (I), (II-a), (II-b), or (II-c), or (III), wherein
formula (I) is 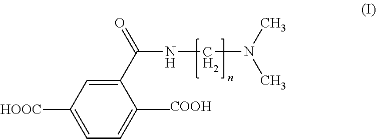
wherein n is an integer from 1 to 20,
formulae (II-a), (II-b), and (II-c) are 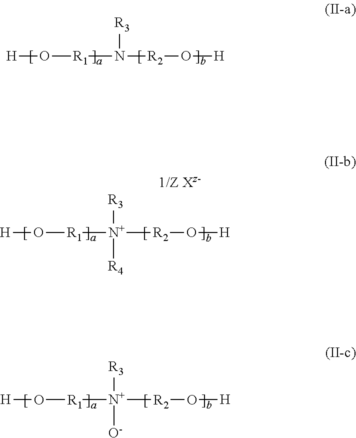
wherein
R₁ and R₂ are each, independently, a linear or branched alkylene group represented by the formula (CₙH₂ₙ), wherein n is 2, 3 or 4,
R₃ is a group of the formula —(CⱼH₂ⱼO)ₖ—R₉₈, wherein
j is 2, 3, or 4;
k is, based on a molar average, a number from 0 to 10; and
R₉₈ is selected from the group consisting of: C₆ or higher alkyl; C₆ or higher alkenyl; C₆ or higher hydroxyalkyl; C₆ or higher hydroxyalkenyl; phenyl-(C₆ or higher)-alkyl; phenyl-(C₆ or higher)-alkenyl; (C₆ or higher)-alkyl-phenyl; and (C₆ or higher)-alkenyl-phenyl;
R₄ is a group of the formula —(Cj1H₂ⱼ₁O)ₖ₁—R₉₉, wherein
j1 is 2, 3, or 4;
k1 is, based on a molar average, a number from 0 to 10; and
R₉₉ is selected from the group consisting of: hydrogen; C₁-C₃₀ alkyl; C₂-C₃₀ alkenyl; C₁-C₃₀ hydroxyalkyl; C₂-C₃₀ hydroxyalkenyl; phenyl-(C₁-C₃₀)-alkyl; phenyl-(C₂-C₃₀)-alkenyl; (C₁-C₃₀)-alkyl-phenyl; and (C₂-C₃₀)-alkenyl-phenyl;
a and b are each, independently, based on a molar average, a number from 1 to 200; and
1/z X^{z-} is an anion selected from the group consisting of monovalent anions X⁻ (z=1), divalent anions ⅓ X²⁻ (z=2), and trivalent anions ⅓ X³⁻ (z=3), and formula (III) is 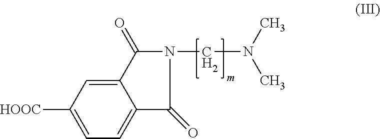
wherein m is an integer from 1 to 20.

18. The aqueous composition according to claim 11, wherein the aqueous composition comprises the one or more cucurbiturils of component Z1) in an amount from 0.01 to 10% by weight, based on the total weight of the aqueous composition.

19. The aqueous composition according to claim 11, wherein the aqueous composition comprises the one or more solubilizing agents of component Z2) in an amount from 0.01 to 50% by weight, based on the total weight of the aqueous composition.

20. The aqueous composition according to claim 11, wherein the one or more cucurbiturils of component Z1) and the one or more solubilizing agents of component Z2) are present in a weight ratio Z1):Z2) of from 1:1 to 1:50.

21. A laundry detergent formulation, fabric conditioner, automatic dishwashing rinse aid formulation, hand dishwashing liquid, air freshener, or hard surface cleaner comprising the aqueous composition according to claim 11.

22. An aqueous composition comprising
Z1) from 0 to 5% by weight cucurbit[5]uril,
from 40 to 60% by weight cucurbit[6]uril,
from 30 to 40% by weight cucurbit[7]uril, and
from 5 to 15% by weight cucurbit[8]uril,
in each case based on the total weight of component Z1);
Z2) one or more solubilizing agents selected from
a) one or more discrete molecules containing nitrogen,
b) one or more polymers comprising one or more structural units derived
from one or more monomers containing nitrogen, and
mixtures of a) and b);
and
Z3) water.

23. The aqueous composition of claim 22, wherein the one or more discrete molecules a) of component Z2) are selected from the group consisting of amine oxides, betaines, quats, glucamides, glucamines, and mixtures thereof.

24. The aqueous composition according to claim 22, wherein the one or more polymers b) of component Z2) comprise one or more structural units derived from N-methyl-N-alkylamines, aziridine, vinylpyrrolidone, vinylimidazole, or one or more monomers of the formulae (I), (II-a), (II-b), or (II-c), or (III), wherein
formula (I) is 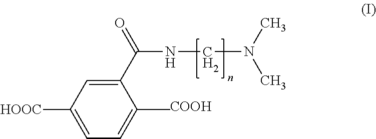
wherein n is an integer from 1 to 20,
formulae (II-a), (II-b), and (II-c) are 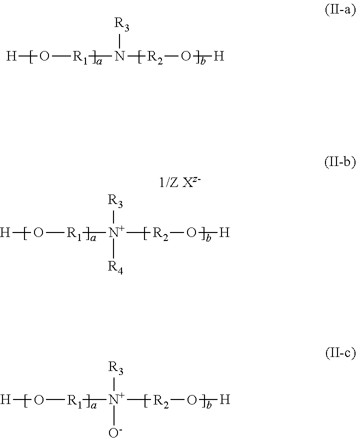
wherein
R₁ and R₂ are each, independently, a linear or branched alkylene group represented by the formula (CₙH₂ₙ), wherein n is 2, 3 or 4,
R₃ is a group of the formula —(CⱼH₂ⱼO)ₖ—R₉₈, wherein
j is 2, 3, or 4;
k is, based on a molar average, a number from 0 to 10; and
R₉₈ is selected from the group consisting of: C₆ or higher alkyl; C₆ or higher alkenyl; C₆ or higher hydroxyalkyl; C₆ or higher hydroxyalkenyl; phenyl-(C₆ or higher)-alkyl; phenyl-(C₆ or higher)-alkenyl; (C₆ or higher)-alkyl-phenyl; and (C₆ or higher)-alkenyl-phenyl;
R₄ is a group of the formula —(Cj1H₂ⱼ₁O)ₖ₁—R₉₉, wherein j1 is 2, 3, or 4;
k1 is, based on a molar average, a number from 0 to 10; and
R₉₉ is selected from the group consisting of: hydrogen; C₁-C₃₀ alkyl; C₂-C₃₀ alkenyl; C₁-C₃₀ hydroxyalkyl; C₂-C₃₀ hydroxyalkenyl; phenyl-(C₁-C₃0)-alkyl; phenyl-(C₂-C₃₀)-alkenyl; (C₁-C₃₀)-alkyl-phenyl; and (C₂-C₃₀)-alkenyl-phenyl;
a and b are each, independently, based on a molar average, a number from 1 to 200; and
1/z X^{z-} is an anion selected from the group consisting of monovalent anions X⁻ (z=1), divalent anions ½ X²⁻ (z=2), and trivalent anions ⅓ X3− (z=3),
and
formula (III) is 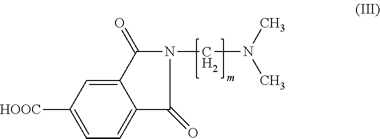
wherein m is an integer from 1 to 20.

25. The aqueous composition according to claim 22, wherein component Z2) comprises one or more selected from
an alkylamidopropyl betaine;
an ethoxylated polyethyleneimine;
a vinylpyrrolidone/vinylimidazole copolymer;
a dimethylamine-epichlorohydrin copolymer;
lauramine oxide;
a compound of the formula (IV) 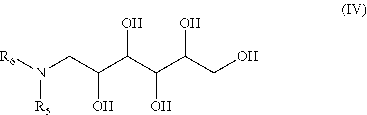
wherein R₅ and R₆ are methyl;
and
a polymer comprising structural units derived from formula (I) 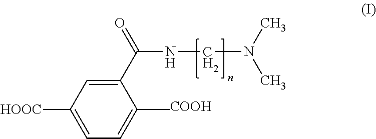
wherein n is an integer from 1 to 20.

26. The aqueous composition according to claim 22, wherein the aqueous composition comprises, based on the total weight of the aqueous composition, component Z1) in an amount from 0.01 to 10% by weight and component Z2) in an amount from 0.01 to 50% by weight.

27. The aqueous composition according to claim 22, wherein the component Z1) and component Z2) are present in a weight ratio Z1):Z2) of from 1:1 to 1:50.
